(19) United States
(12) Patent Application Publication
(10) Pub. No.: US 2006/0166657 A1
(43) Pub. Date: Jul. 27, 2006

(54) Remote caller ID projection device

(76) Inventor: Parag Patel, Marina Del Rey, CA (US)

Correspondence Address: STETINA BRUNDA GARRED & BRUCKER, 75 ENTERPRISE, SUITE 250, ALISO VIEJO, CA, 92656, US

(21) Appl. No.: 11/042,677

(22) Filed: Jan. 25, 2005

(51) Int. Cl. H04M 3/42

(52) U.S. Cl. 455/415

(57) ABSTRACT

A data projection apparatus is provided for projecting caller identification data received from a telephone service provider. The apparatus includes a base telephone unit configured to receive the caller identification data from the telephone service provider and to transmit the caller identification data to a remote projection device. The apparatus includes a remote projection device configured to receive the caller identification data transmitted from the base telephone unit. The remote projection device projects an image adjacent the remote projection device. The base telephone unit is spatially separate from the remote projection device. Further, the image is based upon the caller identification data.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to data projection, and more particularly to a uniquely configured remote projection device and methodology specifically adapted for remotely projecting an image based upon caller identification data.

Modern telephone service providers commonly provide their customers with a caller identification (caller ID) feature as part of a telephone service plan. The caller ID feature typically allows a recipient of a phone call to see a visual display of an incoming caller's name, phone number and time of call. Thus, the recipient may use the caller ID to screen an incoming telephone call, know who the caller is before answering, and to subsequently review a list of calls received.

Typically, the caller ID is provided on a caller ID box adjacent the telephone or a caller ID display located on the telephone handset. However, many circumstances detract from the utility of such caller ID. Sometimes telephones are only available in limited areas of a home—which may force an individual to race throughout her home or into her home from outdoors to answer a telephone call. In such a rush, the individual may undoubtedly find it difficult to reach the telephone in time to read the caller ID display.

In other situations, even though multiple telephones are available throughout the home, caller ID may be available only using telephones in certain parts of the home. Even though the individual may be able to answer the phone, they may be unable to identify the caller before answering or otherwise screen the call.

Although efforts have been made to improve the accessibility of the caller ID display, caller ID is nevertheless difficult to perceive in many situations. Accordingly, there is a need in the art for improved caller ID system that increases the ease with which an individual perceives the caller ID.

### BRIEF SUMMARY OF THE INVENTION

In accordance with an embodiment of the present invention, a data projection apparatus is provided for projecting caller identification data received from a telephone service provider. The apparatus includes a base telephone unit and a remote projection device. The base telephone unit is configured to receive the caller identification data from the telephone service provider. The base telephone unit is also configured to transmit the caller identification data to a remote projection device. The remote projection device is configured to receive the caller identification data transmitted from the base telephone unit and to project an image adjacent the remote projection device. The base telephone unit is spatially separate from the remote projection device. The image is based upon the caller identification data.

According to various embodiments of the present invention, the base telephone unit may be a cellular telephone. The caller identification data may be wirelessly transmittable to the remote projection device. Furthermore, the remote projection device may be utilizable to project the image onto a surface adjacent the remote projection device.

Moreover, the apparatus may also include a caller database. The caller database may be utilizable for entering caller-specific data thereinto. The caller database may be accessible, either selectively or automatically, in response to the caller identification data to retrieve the caller-specific data. Furthermore, the caller database may be includable within the base telephone unit. Additionally, the remote projection device may be configurable to project an image including caller-specific data. The remote projection device may also be configurable to project the image including an informational message such as an email message, SMS text message, picture message, or other message received at the base telephone unit..

In accordance with another embodiment of the present invention, there is provided a method of displaying caller identification data received from a telephone service provider. The method includes the step of receiving the caller identification data from the telephone service provider at a base telephone unit. Next, the method provides for transmitting the caller identification data from the base telephone unit to at least one remote projection device. The base telephone unit is spatially separate from the remote projection device. The method further provides for utilizing the remote projection device to receive the caller identification data and to project an image adjacent the remote projection device. The image is based upon the caller identification data.

The remote projection device may be utilized to project the image onto a surface adjacent the remote projection device. Additionally, the caller identification data may be wirelessly transmitted to the remote projection device. The base telephone unit may be a cellular telephone.

The method may further include the steps of inputting caller-specific data into a caller database, and querying the caller database in response to the caller identification data to retrieve the caller-specific data. The remote projection device may be configurable to project the image including caller-specific data. The remote projection device may also be configurable to project the image including an informational message such as an email message, SMS text message, picture message, or other message received at the base telephone unit.

### BRIEF DESCRIPTION OF THE DRAWINGS

An illustrative and presently preferred embodiment of the invention is shown in the accompanying drawings in which:

FIG. 1 illustrates an exemplary embodiment of a data projection apparatus including a base telephone unit which communicates wirelessly with a remote projection device;

FIG. 2 illustrates another exemplary embodiment of the data projection apparatus wherein the base telephone unit is a cellular telephone which accesses a caller database in response to caller identification data;

FIG. 3 is a block diagram illustrating the functional relationship of the components of the data projection apparatus; and

FIG. 4 is a block diagram illustrating the methodology of displaying the caller identification data received from a telephone service provider utilizing the remote projection device.

### DETAILED DESCRIPTION OF THE INVENTION

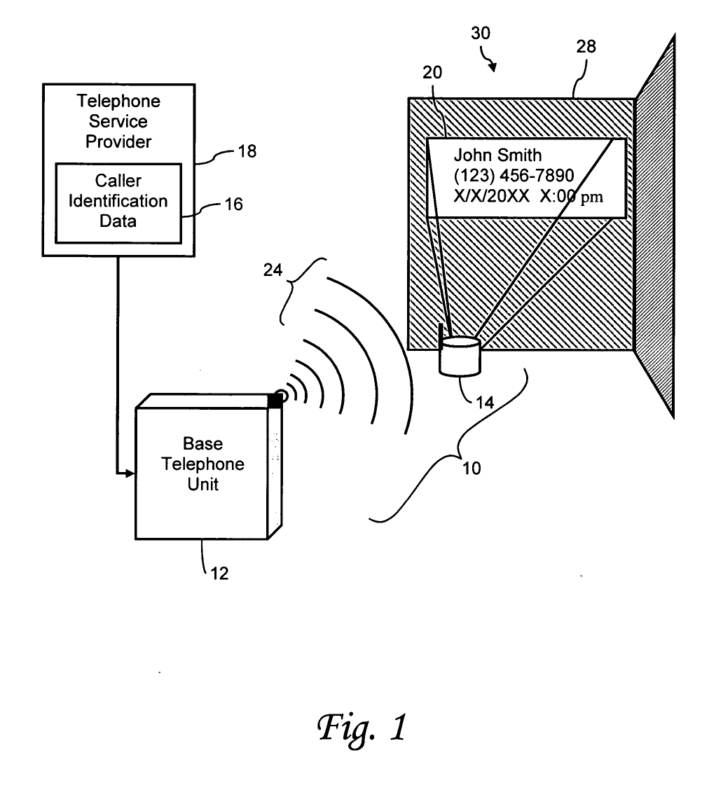

Referring now to the drawings wherein the showings are for the purposes of illustrating the preferred embodiments of the present invention only, and not for the purposes of limiting the same, FIG. 1 illustrates an exemplary embodiment of a data projection apparatus 10 including a base telephone unit 12 which communicates wirelessly with a remote projection device 14 for projecting caller identification data 16 received from a telephone service provider 18. The base telephone unit 12 may be configured to receive the caller identification data 16 from the telephone service provider 18 and to transmit the caller identification data 16 to the remote projection device 14. The remote projection device 14 may be configured to receive the caller identification data 16 transmitted from the base telephone unit 12 and to project an image 20 adjacent the remote projection device 14. The base telephone unit 12 may be spatially separate from the remote projection device 14. The image 20 may be based upon the caller identification data 16.

The remote projection device 14 is spatially separate from the base telephone unit 12. In this regard, the remote projection device 14 may be freely mobile into any desirable location. Thus, in one implementation of the present invention, the base telephone unit 12 may be in one location in a home and the remote projection device 14 may be in another location in the home. For example, the base telephone unit 12 may be located in a central location in the home, such as the kitchen, and the remote projection device 14 may be located in the garage or master bedroom. Additionally, it is contemplated that the remote projection device 14 may be located in an area outside of the home, such as the back yard or another location, such as a guest home or garage. Indeed, it is contemplated that the use of multiple remote projection devices 14 throughout a location such as a home or office allows a user to project the image 20 all around the house/office in easily viewable locations.

In accordance with an aspect of the present invention, the remote projection device 14 may be configured to be free of power cords, communications cables, and the like. Thus, the remote projection device 14 may be freely mobile to any area in or around the home. In order to facilitate its mobility, the remote projection device 14 may wirelessly communicate with the base telephone unit 12. It is contemplated that the remote projection device 14 may also have an independent power source such as a battery insertable thereinto.

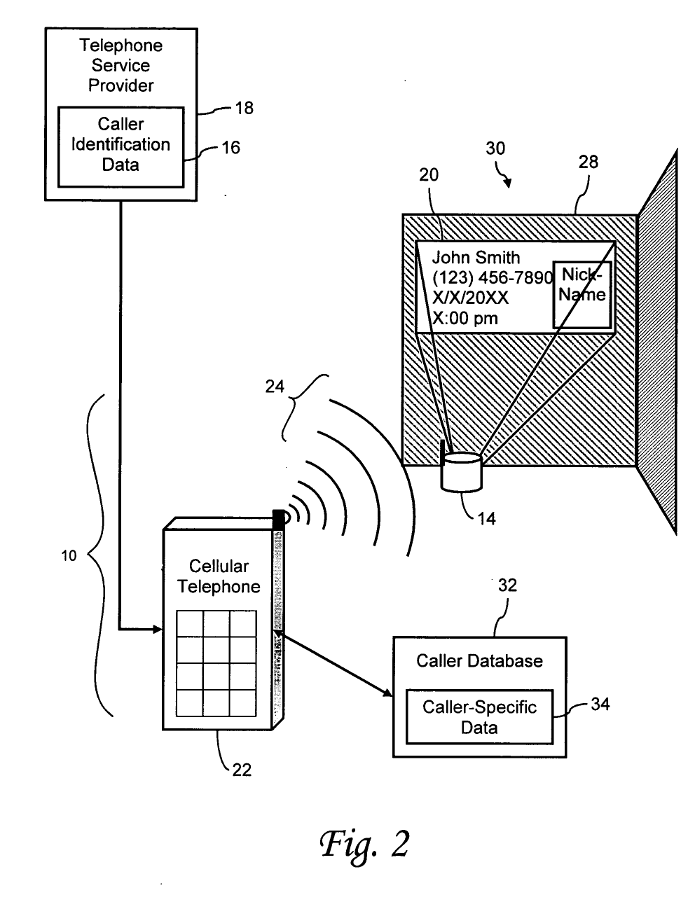

As shown in FIG. 1, the base telephone unit 12 may be configured to receive the caller identification data 16 from the telephone service provider 18. It is contemplated that the caller identification data 16 may be provided by the telephone service provider 18 whenever a telephone call or informational message is received at the base telephone unit 12. The caller identification data 16 may include information regarding a caller's name, a telephone number from which the caller is calling, a date and time on which the call was placed, as well as the informational message and other information as provided by the telephone service provider 18. For example, the informational message may include email messages, SMS text messages, picture messages, and other messages that may be received by the base telephone unit 12. As illustrated in FIGS. 1 and 2, the base telephone unit 12 may transmit the caller identification data 16 to the remote projection device 14. The caller identification data 16 may be transmitted to the remote projection device 14 wirelessly. In this regard, the base telephone unit 12 may be configured to transmit the caller identification data 16 only to selected remote projection devices 14. For example, in a situation where two neighbors both own and utilize the data projection apparatus 10 in their respective homes, each of their respective data projection apparatuses may be configured to produce non-interfering signals unique to each of their respective data projection apparatuses. The base telephone unit 12 may either transmit unique signals to the respective remote projection device 14, or the base telephone unit 12 may project signals only over a selected distance. Thus, the caller identification data 16 transmitted from the base telephone unit 12 may not be received by a source external to the data projection apparatus 10. Nevertheless, the caller identification data 16 may be transmitted utilizing a communications cable. Additionally, it is contemplated that the caller identification data 16 may be sent in an encrypted or other format for protecting the security and privacy of the caller identification data 16.

Referring now to FIG. 2, the base telephone unit 12 may be a cellular telephone 22. The base telephone unit 12 may also be a plurality of cellular telephones. For example, in a home wherein each member of the home utilizes a separate cellular telephone, the data projection apparatus 10 may be configured to selectively recognize selected ones of the cellular telephones and allow transmission of the caller identification data 16 from the selected ones of the cellular telephones to the remote projection device 14. In this regard, the cellular telephone 22 may likewise receive the caller identification data 16 from the telephone service provider 18. The cellular telephone 22 may wirelessly communicate the caller identification data 16 to the remote projection device 14 utilizing evolving new technologies, such as Bluetooth™, WI-FI® and/or WiMAX™. In accordance with an implementation of the present invention, it is contemplated that the caller identification data 16 transmitted by the cellular telephone 22 may be transmitted only to the respective remote projection device(s) 14. For example, the data projection apparatus 10 may be configured with the caller identification data 16 being transmitted to the remote projection device 14 via a line-of-sight infrared signal. Furthermore, it is contemplated that various electromagnetic waves 24 may be utilized in order to ensure that the caller identification data 16 transmitted from the base telephone unit 12 may not be received by a source external to the data projection apparatus 10.

According to another aspect of the present invention, as shown in FIGS. 1-3, the remote projection device 14 may be configured to receive the caller identification data 16 transmitted from the base telephone unit 12. In this regard, the remote projection device 14 may also be equipped with wireless communication technology, such as the aforementioned Bluetooth™ technology. Such an implementation may be most useful when the base telephone unit 12 is the cellular telephone 22. Thus, the caller identification data 16 may be received at the remote projection device 14 via an electromagnetic wave 24, such as radiofrequency waves. In this regard, it is contemplated that desirable electromagnetic signals may be utilized depending on the desired range of communication. The remote projection device 14 may have various ranges of operation (and therefore be locatable at varying distances from the base telephone unit 12) relative to the electromagnetic signal utilized for the application. Certain ranges of operation may be desirable depending on the identity of the base telephone unit 12. For example, if the base telephone unit 12 is a home telephone, then the range of operation may need to be at least several miles as the individual requires. However, other implementations may utilize much smaller ranges of operation as also determined by the individual's needs.

In accordance with another implementation of the present invention, the data projection apparatus 10 is configured to utilize a plurality of remote projection devices 14. The remote projection devices 14 may each receive the caller identification data 16 transmitted from the base telephone unit 12. However, the data projection apparatus 10 may be configured with the base telephone unit 12 transmitting the caller identification data 16 to a selected one of the remote projection devices, and the selected one of the remote projection devices communicating the caller identification data 16 to other ones of the remote projection devices. In this regard, as similarly mentioned above, the selected one of the remote projection devices may communicate the caller identification data 16 to the other ones of the remote projection devices via an infrared signal or other electromagnetic wave 24 as desired.

According to an implementation of the present invention, an individual may employ the remote projection device 14 at her workplace to be apprised of calls made to her base telephone unit 12, whether the base telephone unit 12 be a home telephone or the cellular telephone 22. Thus, the remote projection device 14 may continuously inform an individual as to calls received by the base telephone unit 12, wherever the individual may be located. The individual may then decide to contact the caller through an available telephone. As mentioned above, the portability of the remote projection device 14 allows use of the remote projection device 14 in a variety of locations such as areas in or around the home, the office, an automobile, or other locations as desired by the individual. Moreover, variations in the type of electromagnetic wave 24 utilized may provide a greater range of use of the remote projection device 14.

In accordance with yet another aspect of the present invention, the remote projection device 14 may be configured to project the image 20 adjacent the remote projection device 14. As shown in FIGS. 1 and 2, the image 20 may include the information conveyed by the caller identification data 16 such as the caller identification data 16 may include information such as the caller's name, the telephone number from which the caller is calling, and the date and time of the call. The remote projection device 14 may utilize LED, laser, or other optical beams and projection configurations in order to project the image 20.

The remote projection device 14 may project the image 20 onto a surface 26 adjacent the remote projection device 14. Nevertheless, the image 20 may also be a hologram. As illustrated in FIGS. 1 and 2, the surface 26 may be a wall 28 of a room 30. However, it is contemplated that the surface 26 may be any structure or object upon which the image 20 may be viewed. Such alternative surfaces include doors, furniture, and other opaque objects. In an exemplary embodiment, the surface 26 may be configured to be substantially flat, such that the image 20 may be seen in its entirety and proper proportion.

In accordance with another aspect of the present invention, the image 20 is configured to include information identifying the base telephone unit 12. For example, as mentioned above, in an embodiment wherein multiple cellular telephones are utilized as the base telephone unit 12, and a given one of the multiple cellular telephones transmits the caller identification data 16 to the data projection device 14, the image 20 may include information identifying the given one of the multiple cellular telephones. It is contemplated that the image 20 may include information identifying the base telephone unit 12 when the base telephone unit 12 functions as a cellular telephone away from the home and a home telephone within a certain range of the home, as presently performed in certain European and Asian countries.

The remote projection device 14 may also be configurable to project the image 20 including an informational message such as an email message, SMS text message, picture message, or other message received at the base telephone unit 12. In one implementation of the present invention, the cellular telephone 22 may transmit the informational message to the remote projection device 14. The remote projection device 14 may then project the image 20 being based upon the caller identification data 16, which may include the informational message. Often, such informational messages may be frequently received on cellular telephones. In this regard, the data projection apparatus 10 may be configured to selectively or automatically display the informational message as part of the image 20. For example, selectively displaying the informational message may be especially important in a home where several cellular telephones are utilized as the base telephone unit 12. However, in this example, it is also contemplated that the data projection apparatus 10 may be configured with multiple remote projection devices 14 such that the each of the remote projection devices 14 displays incoming calls for all of the cellular telephone, but only displays informational messages received by a given one of the several cellular telephones. For example, in order to promote privacy and other virtues, informational messages corresponding to a teenager's cellular telephone may be displayed only by the remote projection device 14 in her room, and not by other remote projection devices 14 in other locations of the house.

As mentioned above, it is contemplated that the remote projection device 14 may be configured to project the image 20 including an informational message such as an email message. In this regard, the data projection apparatus 10 may include an interface with a personal computer for passing electronic signals such as email messages. This would be in addition to a telephone based interface with the telephone service provider 18.

According to another implementation of the present invention, the remote projection device 14 may be sized to be portable on a keychain or in a purse. Thus, when a call is made to the individual's base telephone unit 12, whether it be her home telephone or a cellular phone, the individual may only need to find her keys or purse. The remote projection device 14 may then project the image 20 based upon the caller identification data 16. In an exemplary embodiment, an individual may selectively activate the remote projection device 14 in order to project the image 20. In this regard, the remote projection device 14 may include an actuation switch for selectively activating the remote projection device 14 in order to project the image 20. Additionally, the remote projection device 14 may also include an indicator that indicates the reception of caller identification data 16 from the base telephone unit 12; upon indication by the indicator, the individual may then selectively activate the remote projection device 14 in order to project the image 20.

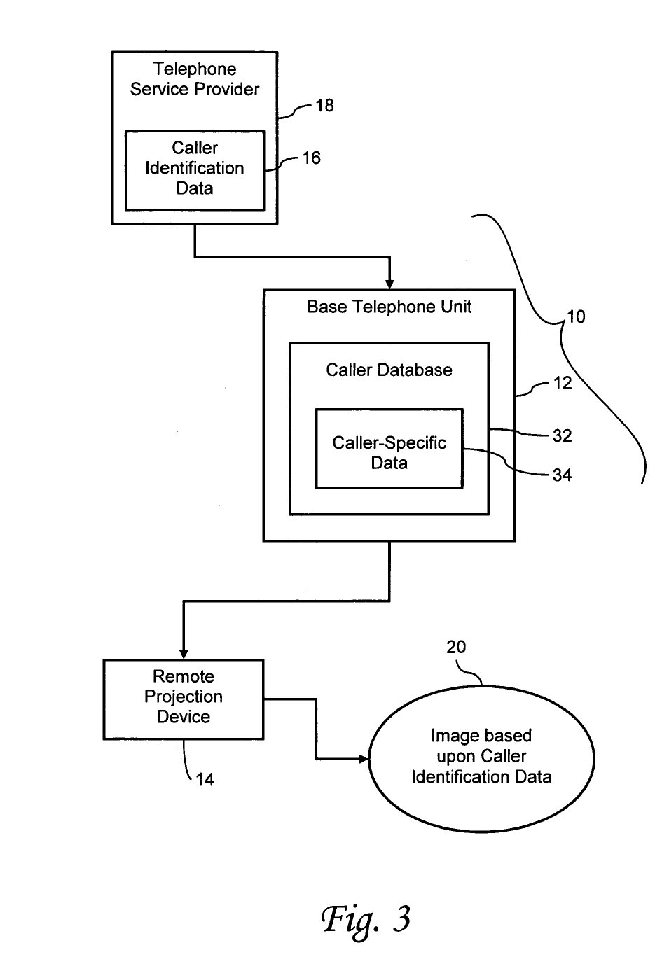

As illustrated in FIGS. 2 and 3, the apparatus may further include a caller database 32. The caller database 32 may be utilizable for entering caller-specific data 34 thereinto. The caller database 32 may be accessible, either selectively or automatically, in response to the caller identification data 16 to retrieve the caller-specific data 34. The caller-specific data 34 may be entered into the caller database 32 by an individual. The caller-specific data 34 may include information such as the name of a caller, a nickname for the caller, the location from which the caller is calling, the relationship of the caller to the individual, or other pertinent information. Such information may be incorporated into the image 20 as shown in FIG. 2. Therefore, in response to the caller identification data 16 received from the telephone service provider 18, the caller database 32 may access the caller-specific data 34 and communicate the same to the remote projection device 14. Thus, the remote projection device 14 may be configurable to project the image 20 including the caller-specific data 34. Additionally, an individual may customize the image 20 through entering the caller-specific data 34 into the caller database 32, upon which the image 20 may be based. For example, if the individual believes that a particular call is very important, the image 20 may be accordingly altered to indicate the urgency of the call. In another example, if the individual knows that a given call is undesirable, the image 20 may further be altered to indicate the undesirability of the call.

Referring now to FIG. 3, in another implementation of the present invention, the caller database 32 may be includable within the base telephone unit 12. It is contemplated that an individual may therefore enter the caller-specific data 34 into the caller database 32 utilizing the base telephone unit 12.

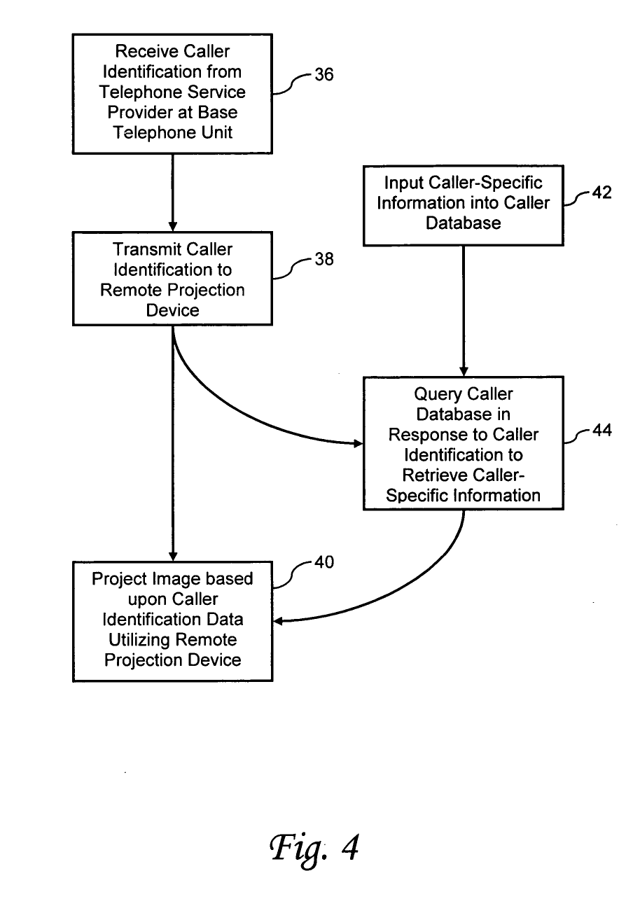

In accordance with an embodiment of the present invention, referring now to FIG. 4, a method of displaying caller identification data 16 received from a telephone service provider 18 is provided. The method includes the steps of: receiving the caller identification data 16 from the telephone service provider 18 at a base telephone unit 12 (i.e., receiving step 34, as shown on FIG. 4); transmitting the caller identification data 16 from the base telephone unit 12 to at least one remote projection device 14, the base telephone unit 12 being spatially separate from the remote projection device 14 (i.e., transmitting step 38, as shown on FIG. 4); and utilizing the remote projection device 14 to project an image 20 adjacent the remote projection device 14, the image 20 being based upon the caller identification data 16 (i.e., projecting step 40, as shown on FIG. 4). An exemplary method and order in which these steps may be performed is provided; however, it is contemplated that these steps may be rearranged in other various orderings in order to achieve substantially the same purpose.

As shown in FIG. 4, the receiving step 34 includes receiving the caller identification data 16 from the telephone service provider 18 at the base telephone unit 12 may be accomplished by utilizing either communications cables or wireless technology, as described above. It is contemplated that the receiving step 34 may include receiving the caller identification data 16 directly at the base telephone unit 12, or the caller identification data 16 may pass through intermediaries and eventually be delivered to the base telephone unit 12. Additionally, it is contemplated that the caller identification data 16 may be converted into various signals in order to facilitate the communication thereof.

Referring again to FIG. 4, the transmitting step 38 may include transmitting the caller identification data 16 from the base telephone unit 12 to the at least one remote projection device 14 may also be accomplished utilizing either communications cables or wireless technology, as described above. In this manner, as also described above, the base telephone unit 12 may be spatially separate from the remote projection device 14. Additionally, as in one embodiment of the invention, the transmitting step 38 may include selectively transmitting the caller identification data 16 from the base telephone unit 12 as desired by an individual. In this regard, the base telephone unit 12 may be configured with a control panel through which the individual may control the timing of the transmission. The individual may also elect to switch on or off the transmission as desired.

As illustrated in FIG. 4, the projecting step 40 may include utilizing the remote projection device 14 to receive the caller identification data 16 and to project the image 20 adjacent the remote projection device 14. The image 20 may be based upon the caller identification data 16. In an implementation of the projecting step 40, it is contemplated that the image 20 may be selectively projected by an individual or automatically projected when the caller identification data 16 is received by the remote projection device 14. In this regard, it is contemplated that the image 20 may also be selectively switched off by an individual or shut off automatically after a period of time to ensure conservation of energy power. As described above, the remote projection device 14 may be utilized to project the image 20 onto a surface 26 adjacent the remote projection device 14. Additionally, the caller identification data 16 may also be wirelessly transmitted to the remote projection device 14. As also detailed above, in one implementation of the present invention, the base telephone unit 12 may be a cellular telephone 22.

Referring again to FIG. 4, the method may further include the steps of: inputting caller-specific data 34 into a caller database 32 (i.e. inputting step 42, as seen in FIG. 4); and querying the caller database 32 in response to the caller identification data 16 to retrieve the caller-specific data 34 (i.e. querying step 44, as seen in FIG. 4). The remote projection device 14 may be configurable to project an image 20 including the caller-specific data 34. As detailed above, the caller database 32 may be includable within the base telephone unit 12. The inputting step 42 may include inputting the caller-specific data 34 into the caller database 32 may be accomplished by an individual, as mentioned above. The querying step 44 may include querying the caller database 32 in response to the caller identification data 16 to retrieve the caller-specific data 34 may be accomplished automatically or selectively as the individual so desires. The remote projection device 14 may be configurable to project the image 20 including caller-specific data 34. The remote projection device 14 may also be configurable to project the image 20 including an informational message such as an email message, SMS text message, picture message, or other message received at the base telephone unit 12.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

What is claimed is:

1. A data projection apparatus for projecting caller identification data received from a telephone service provider, the apparatus comprising:
a base telephone unit configured to receive the caller identification data from the telephone service provider and to transmit the caller identification data to a remote projection device; and
a remote projection device configured to receive the caller identification data transmitted from the base telephone unit and to project an image adjacent the remote projection device, the remote projection device being spatially separate from the base telephone unit, the image being based upon the caller identification data.

2. The apparatus of claim 1 wherein the base telephone unit is a cellular telephone.

3. The apparatus of claim 1 wherein the remote projection device is utilizable to project the image onto a surface adjacent the remote projection device.

4. The apparatus of claim 1 wherein the caller identification data is wirelessly transmittable to the remote projection device.

5. The apparatus of claim 1 further including a caller database utilizable for entering caller-specific data thereinto, the caller database being accessible in response to the caller identification data to retrieve the caller-specific data.

6. The apparatus of claim 5 wherein the caller database is includable within the base telephone unit.

7. The apparatus of claim 5 wherein the remote projection device is configurable to project the image including caller-specific data.

8. The apparatus of claim 1 wherein the remote projection device is configurable to project the image including an informational message.

9. A method of displaying caller identification data received from a telephone service provider, the method comprising:
a. receiving the caller identification data from the telephone service provider at a base telephone unit;
b. transmitting the caller identification data from the base telephone unit to at least one remote projection device, the base telephone unit being spatially separate from the remote projection device; and
c. utilizing the remote projection device to receive the caller identification data and to project an image adjacent the remote projection device, the image being based upon the caller identification data.

10. The method of claim 9 wherein the remote projection device is utilized to project the image onto a surface adjacent the remote projection device.

11. The method of claim 9 wherein the caller identification data is wirelessly transmitted to the remote projection device.

12. The method of claim 9 wherein the base telephone unit is a cellular telephone.

13. The method of claim 9 further including the steps of:
inputting caller-specific data into a caller database; and
querying the caller database in response to the caller identification data to retrieve the caller-specific data.

14. The method of claim 9 wherein the remote projection device is configurable to project the image including caller-specific data.

15. The method of claim 9 wherein the remote projection device is configurable to project the image including an informational message.
